(19) United States
(12) Patent Application Publication
(10) Pub. No.: US 2012/0096453 A1
(43) Pub. Date: Apr. 19, 2012

(54) Software Package Management Mechanism

(76) Inventors: Jon A. Meilstrup, Longmont, CO (US); Michael E. Haller, Niwot, CO (US); Kevin J. Bodily, Glendale, AZ (US)

(21) Appl. No.: 12/904,248

(22) Filed: Oct. 14, 2010

(51) Int. Cl. G06F 9/445

(52) U.S. Cl. 717/175

(57) ABSTRACT

A computer system disclosed. The computer system includes a processing unit, a computer-readable medium coupled to the processing unit, a Windows operating system executed from the computer-readable medium and an Extension PacKage (EPK) file stored on the computer-readable medium. The EPK file includes one or more software package files and a version file having metadata information to enable installation of the one or more software package files. The computer system also includes a package manager, executed from the computer-readable medium by the processing unit, to install the one or more software package files for operation on the Windows operating system.

### FIELD OF THE INVENTION

The invention relates to the field of software distribution. Particularly, the invention relates to management of software packages.

### BACKGROUND

Generation of new software packages, or upgrades to current software packages, must be installed on computers after distribution. This installation and upgrading of software packages on computers often requires a package manager to manage the installation. A software package management system (PMS) is a collection of software tools that automate the process of installing, upgrading, configuring, and removing software packages for a computer's operating system in a consistent manner. The PMS typically maintains a database of software dependencies and version information to prevent software mismatches and missing prerequisites.

One such PMS is the RPM Package Manager (RPM). RPM is a command line driven package management system capable of installing, uninstalling, verifying, querying, and updating computer software packages. However, the operation of RPM is limited to the Linux and UNIX operating systems. Thus, there no comparable package management system available on the Windows operating systems.

Accordingly, a mechanism for implementing a command line driven package management system for the Windows operating system is desired.

### SUMMARY

In one embodiment a computer system disclosed. The computer system includes a processing unit, a computer-readable medium coupled to the processing unit, a Windows operating system executed from the computer-readable medium an Extension PacKage (EPK) file stored on the computer-readable medium. The EPK file includes one or more software package files and a version file having metadata information to enable installation of the one or more software package files. The computer system also includes a package manager, executed from the computer-readable medium by the processing unit, to install the one or more software package files for operation on the Windows operating system.

In another embodiment, a method is disclosed. The method includes storing an EPK file including one or more software package files and a version file having metadata information to enable installation of the one or more software package files on a computer-readable medium, and a package manager processing the EPK file to install the one or more software package files for operation on a Windows operating system.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 illustrates one embodiment of software package distribution;

FIG. 3 is a flow diagram illustrating one embodiment for managing software package installation; and

FIG. 4 illustrates one embodiment of a computer system.

### DETAILED DESCRIPTION

A mechanism for implementing a software package management system for the Windows operating system is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

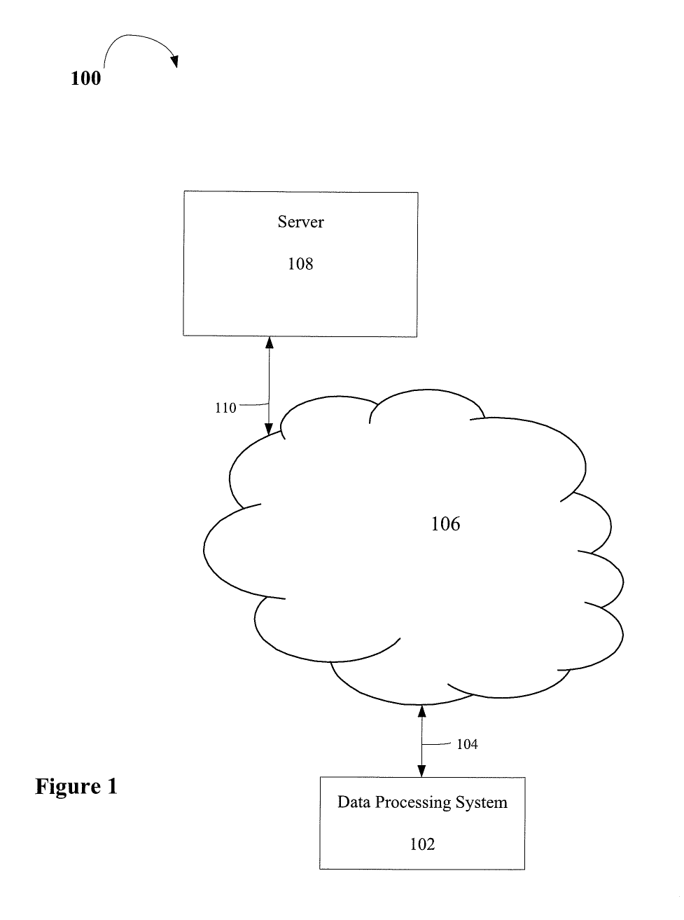

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a server 108 that serves data over network 106 via communications link 110 between server 108 and network 106. Server 108 subsequently transmits and receives data via communications link 110 to one or more data processing system 102. In one embodiment, server 108 distributes software to a data processing system 102 via network 106.

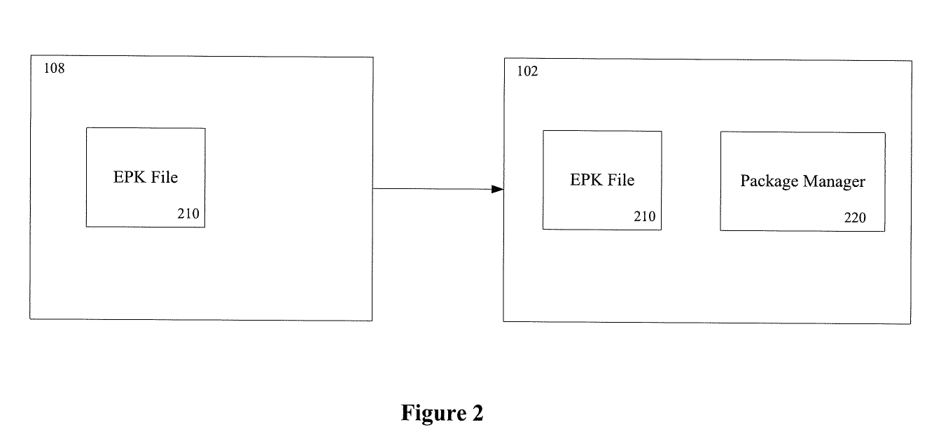

FIG. 2 illustrates one embodiment of software package distribution from server 108 to a data processing system 102 via network 106. In such an embodiment, a software vendor operating server 108 has a new, or upgrade to a current, software package that is to be distributed and installed at data processing system 102. To facilitate the distribution, components of the software package are logically grouped to form an Extension PacKage (EPK) file 210.

In one embodiment, EPK file 210 includes the software package files to be installed, a version file that includes information regarding the version of the package, and metadata that enables installation, query and uninstallation of the software package at data processing system 102. According to one embodiment, the software package files within EPK file 210 may include individual components of a comprehensive software package. Thus, EPK file 210 enables updating individual packages of the comprehensive software package, rather than re-installation of the entire package at once.

EPK file 210 also includes a prerequisites file used during installation of the software package files. The prerequisites included in the prerequisites file establish the interdependency of the software package files in which certain files dependent on one or more other files cannot be installed until after the files from which it depends. In a further embodiment, EPK file 210 includes a post installation command script that is activated upon installation of EPK file 210.

According to one embodiment, the files within EPK file 210 are compressed using a ZIP file format and named with a .epk extension (e.g., “PROGFILE.epk”). Once completed, EPK file 210 is transmitted to data processing system 102. However in other embodiments, EPK file 210 may be downloaded to EPK file 210 via a machine readable medium (e.g., floppy disk, compact disc (CD-ROM), ESB drive, etc.).

Once downloaded at data processing system 102, EPK file 210 is processed by package manager 220. In one embodiment, package manager 220 includes tools that provide installation and uninstallation of EPK file 210 and the included software package files. In a further embodiment, package manager 220 includes tools to query EPK files on data processing system 102 and provide a configurable installation directory. In one embodiment, package manager 220 is pre-installed at data processing system 102 prior to receiving EPK file 210. However in other embodiments, package manager 220 may be distributed to data processing system 102 along with EPK file 210.

According to one embodiment, EPK file 210, upon being unzipped by package manager 220, includes the following files, referenced from the root of the zip file:
/version
/installed/post/PROGFILE.sh
   where PROGFILE is the name of the epk package, as included in the version file. EPK file 210 also includes other files that are specific to the package being delivered.

In one embodiment, the version file includes the metadata about the package. A sample version file includes:
Name: doc1
Version: 2.1.1.25-29.0
Requires: afpvwb, doc

The above sample describes a package named “doc1” that is version 2.1.1.25-29.0, and has afpvwb and doc packages as prerequisites for installation.

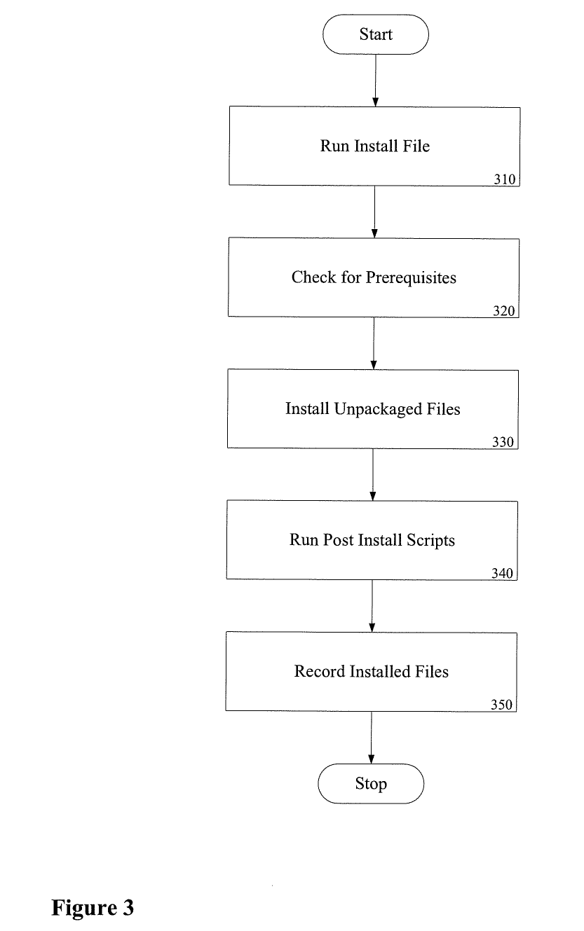

FIG. 3 is a flow diagram illustrating one embodiment of a process performed by package manager 220 for installing EPK file 210. At processing block 310, EPK file 210 is installed by running epk_install doc.epk. At processing block 320, epk_install doc.epk checks for prerequisites. At processing block 330, the unpackaged files are installed in the default installation directory upon the prerequisites being satisfied. At processing block 340, post install scripts are run to setup the software package. In one embodiment, the post install scripts are located in EPK file 210 as installed/post/doc1.sh. At processing block 350, package manager 220 records the files that were installed on data processing system 102. Recording these files enables package manager 220 to locate files for later removal of the package upon running the uninstall file (e.g., epk_uninstall).

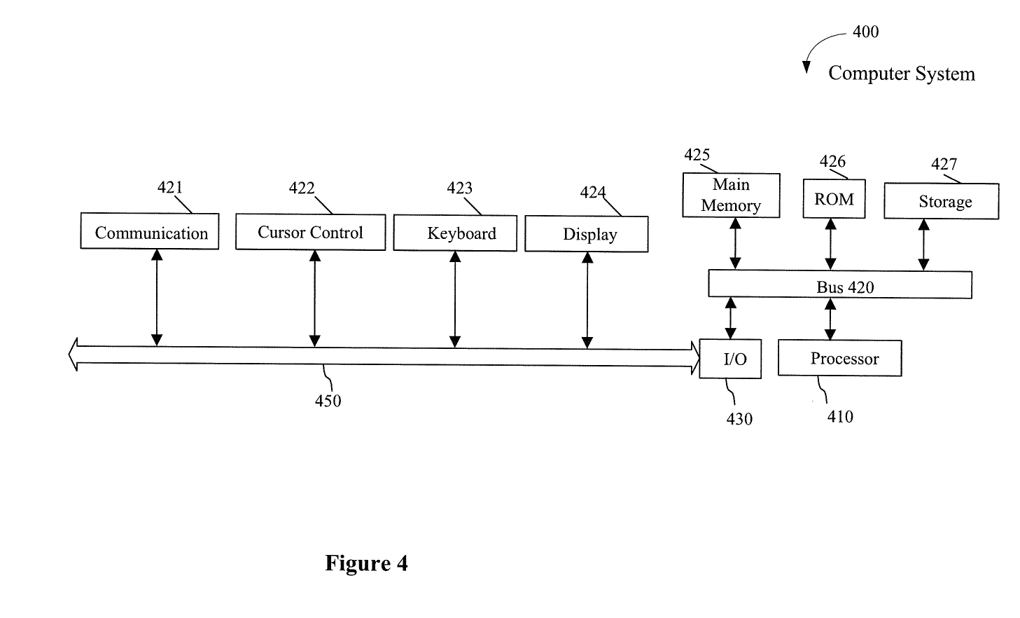

FIG. 4 illustrates a computer system 400 on which data processing system 102 and/or server 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 325 also may be used for storing temporary variables or other intermediate information during execution of instructions by processor 410. Computer system 400 also may include a read only memory (ROM) or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer system comprising:
a processing unit;
a computer-readable medium coupled to the processing unit;
a Windows operating system executed from the computer-readable medium;
an Extension PacKage (EPK) file stored on the computer-readable medium, including:
one or more software package files; and
a version file having metadata information to enable installation of the one or more software package files; and
a package manager, executed from the computer-readable medium by the processing unit, to install the one or more software package files for operation on the Windows operating system.

2. The computer system of claim 1 wherein the package manager decompresses the EPK file from a zip file format prior to installation of the one or more software package files.

3. The computer system of claim 1 wherein the EPK file further comprises a prerequisites file used by the package manager during installation of the one or more software package files.

4. The computer system of claim 3 wherein the EPK file further comprises a post installation command script that is activated upon installation of the EPK file.

5. The computer system of claim 1 wherein the version file further comprises:
query metadata information; and
uninstall metadata information.

6. The computer system of claim 5 wherein the package manager uses the query metadata information to query EPK files on computer-readable medium.

7. The computer system of claim 5 wherein the package manager uses the uninstall metadata information to uninstall the one or more software package files from computer-readable medium.

8. The computer system of claim 1 wherein the one or more software package files include individual components of a comprehensive software package.

9. The computer system of claim 8 wherein the software package updates the software package by installing only a first of the one or more software package files.

10. A computer generated method comprising:
storing an Extension PacKage (EPK) file on a computer-readable medium, the EPK file including:
one or more software package files; and
a version file having metadata information to enable installation of the one or more software package files; and
a package manager processing the EPK file to install the one or more software package files for operation on a Windows operating system.

11. The method of claim 10 wherein processing the EPK file further comprises the package manager decompressing the EPK file from a zip file format prior to installing the one or more software package files.

12. The method of claim 10 wherein the EPK file further comprises:
a prerequisites file; and
post installation command script.

13. The method of claim 12 wherein processing the EPK file further comprises the package manager examining the prerequisites file to check for prerequisites for installing the one or more software package files.

14. The method of claim 13 wherein the one or more software package files are installed upon the prerequisites being satisfied.

15. The method of claim 13 wherein processing the EPK file further comprises the package manager executing the post installation command script.

16. The method of claim 15 wherein processing the EPK file further comprises the package manager recording which of the one or more software package files that were installed.

17. The method of claim 16 wherein the version file further comprises:
query metadata information; and
uninstall metadata information.

18. The method of claim 17 wherein the package manager uses the uninstall metadata information to uninstall the one or more software package files from computer-readable medium.

19. The method of claim 17 wherein the package manager uses the query metadata information to query EPK files on computer-readable medium.

20. An article of manufacture comprising a machine-readable medium including data that, when accessed by a machine, cause the machine to perform operations comprising:
storing an Extension PacKage (EPK) file including:
one or more software package files; and
a version file having metadata information to enable installation of the one or more software package files; and
a package manager processing the EPK file to install the one or more software package files for operation on a Windows operating system.
